(19) United States
(12) Patent Application Publication
(10) Pub. No.: US 2016/0242109 A1
(43) Pub. Date: Aug. 18, 2016

(54) METHOD FOR SEARCHING WIRELESS LAN AND MOBILE DEVICE SUPPORTING THE SAME

(71) Applicant: INTELLECTUAL DISCOVERY CO., LTD., Seoul (KR)

(72) Inventors: Jin Sam KWAK, Uiwang-si (KR); Ju Hyung SON, Uiwang-si (KR); Hyun Oh OH, Gwacheon-si (KR); Yong Ho KIM, Uiwang-si (KR)

(73) Assignee: INTELLECTUAL DISCOVERY CO., LTD., Seoul (KR)

(21) Appl. No.: 15/067,581

(22) Filed: Mar. 11, 2016

Related U.S. Application Data
(63) Continuation of application No. PCT/KR2014/008519, filed on Sep. 12, 2014.

(30) Foreign Application Priority Data
Sep. 12, 2013 (KR) 10-2013-0109690
Sep. 17, 2013 (KR) 10-2013-0111554
Mar. 31, 2014 (KR) 10-2014-0038271
Mar. 31, 2014 (KR) 10-2014-0038296

(51) Int. Cl. H04W 48/16

(52) U.S. Cl. CPC H04W 48/16; H04W 84/12

(57) ABSTRACT

A method for searching a wireless LAN by a mobile device is provided. The method may include receiving, by the mobile device, a setting parameter required to start searching for a wireless LAN access point from a base station; determining, by the mobile device, whether or not to start searching for the wireless LAN access point on the basis of the setting parameter; and starting, by the mobile device, searching for the wireless LAN access point if a condition for starting a search is satisfied.

### CROSS-REFERENCE TO RELATED APPLICATION

This application is a continuation application of PCT Application No. PCT/KR2014/008519 filed on Sep. 12, 2014, which claims the benefit of Korean Patent Application No. 10-2014-0038296 filed on Mar. 31, 2014, Korean Patent Application No. 10-2014-0038271 filed on Mar. 31, 2014, Korean Patent Application No. 10-2013-0111554 filed on Sep. 17, 2013 and Korean Patent Application No. 10-2013-0109690 filed on Sep. 12, 2013, the entire disclosures of which are incorporated herein by reference.

### TECHNICAL FIELD

The present disclosure relates to a method for searching a wireless LAN and a mobile device supporting the same.

### BACKGROUND

A base station in a cellular network transmits/receives data to/from devices included in a wide service area, i.e., coverage. However, the cellular network base station has a wide coverage range, but has a lower data transmission speed than a wireless LAN, and charges a data communication fee for data transmission to a user on a per-packet basis.

On the other hand, the wireless LAN does not charge a data communication fee for data transmission to a user on a per-packet basis, and has a high data transmission speed. However, an access point of the wireless LAN has a narrow coverage range, and, thus, a mobile device cannot freely transmit/receive data.

Due to these characteristics of the cellular network and the wireless LAN, a mobile device capable of accessing both of the cellular network and the wireless LAN searches an accessible wireless LAN access point before starting data communication, and if there is no accessible wireless LAN access point, the mobile device performs data communication through the cellular network.

However, in order to search a wireless LAN access point, the mobile device needs to continuously apply power to a wireless LAN interface and regularly checks whether a wireless LAN signal is received from a wireless LAN access. Therefore, there is an increase in a load required for searching and accessing a wireless LAN access point.

Recently, in order to solve sharply increased data problems in a mobile communication network, there has been actively studied data offloading which is performed using an unlicensed band by interworking with a wireless LAN which can be freely used without permission. Further, the 3rd Generation Partnership Project (3GPP) established the cellular-wireless LAN interworking standards. Accordingly, there has been an attempt to solve traffic congestion problems in a cellular network by performing subscriber authentication to get access to a 3GPP network even if access is made through a wireless LAN.

Further, in order to solve sharply increased data traffic problems in a cellular system, the 3GPP LTE-A Release 12 has standardized cellular-wireless LAN interworking or small cell access. The most important problem to be solved for the cellular-wireless LAN interworking or small cell access is to detect a wireless LAN or a small cell as an access target and rapidly make a connection. Accordingly, in the Institute of Electrical and Electronics Engineers (IEEE) 802.11, the standards for more rapid access to a wireless LAN are defined.

The Quality of Service (QoS) structure for wireless LAN interworking as defined in the 3GPP standards provides Wireless Local Area Network (WLAN) 3GPP IP access in a 3GPP network using a wireless LAN. That is, traffic in a 3GPP network can be distributed through a wireless LAN by wireless LAN interworking.

However, in order to access the wireless LAN, a detection process for obtaining information required for access needs to be performed, and, thus, an access delay occurs. Further, a wireless packet (control frame) needs to be transmitted/received, and, thus, power consumption occurs.

Further, there are too many wireless LAN access points in a cell radius of a base station. Therefore, if a mobile device is moved without knowing which point a wireless LAN access point is present in the cell radius, the mobile device having two kinds of wireless modules including a wireless LAN module and a cellular module repeatedly performs scanning for searching a wireless LAN while communicating with a cellular base station, which results in battery power consumption of the mobile device. Further, if the mobile device has one kind of wireless module, in order to communicate with a cellular base station or a wireless LAN access point, the mobile device needs to switch to a corresponding wireless mode for communication. That is, simultaneous communication cannot be made between the cellular and wireless LAN modules, and, thus, when the wireless LAN is searched, communication with the cellular base station is interrupted.

The above-described example is described in Korean Patent Laid-open Publication No. 10-2008-0049894 (entitled “Apparatus and method for searching wireless LAN in portable terminal”). To be specific, Korean Patent Laid-open Publication No. 10-2008-0049894 describes the method including: upon attaching a wireless LAN, mapping and storing cell information on a present position and information on the attached wireless LAN; when entering a mode concurrently supporting a cellular network and a wireless LAN in a state where a connection to the cellular network is made, comparing the stored cell information with connected cell information; and searching for a wireless LAN using the wireless LAN information mapped to the stored cell information, when the stored cell information is consistent with the connected cell information.

Meanwhile, a base station in a cellular network transmits/receives data to/from devices included in a wide service area. However, a data transmission speed in a boundary area of a cell becomes lower than a data transmission speed in a central area of the cell. In order to compensate this, a small cell has been used. However, if the same frequency is used between cells, interference occurs, and a handover frequently occurs due to a movement of a wireless communication device into a small cell service area. Therefore, a service interruption frequently occurs.

Accordingly, a method for performing a handover while minimizing a service interruption is needed.

Regarding the present disclosure, U.S. Pat. No. 8,279,830 (“Method of performing handover for a dual transfer mode in a wireless mobile communication system”) describes a method of receiving information of a neighbor base station and performing a handover by a dual-mode device.

Further, EP Patent No. EP1744580 (“Dual-mode mobile terminal and method for handover of packet service call between different communication networks”) describes a method for providing communication including a handover caused by a movement in a CDMA/WCDMA dual-mode device.

### DISCLOSURE OF THE INVENTION

### Problems to be Solved by the Invention

In view of the foregoing, the present disclosure provides a method that enables a mobile device on the move to autonomously determine whether to start searching for a wireless LAN access point and more efficiently search the wireless LAN access point by receiving mobility information of the mobile device from a base station.

Further, the present disclosure provides a wireless communication system and method that reduces a handover delay by using a wireless device which can operate in a dual mode.

However, problems to be solved by the present disclosure are not limited to the above-described problems. There may be other problems to be solved by the present disclosure.

### Means for Solving the Problems

In accordance with an aspect of the present disclosure, a method for searching a wireless LAN by a mobile device may include: receiving, by the mobile device, a setting parameter required to start searching for a wireless LAN access point from a base station; determining, by the mobile device, whether or not to start searching for the wireless LAN access point on the basis of the setting parameter; and starting, by the mobile device, searching for the wireless LAN access point if a condition for starting a search is satisfied.

In accordance with another aspect of the present disclosure, a mobile device may include: a memory in which a program for performing a wireless LAN search is stored; one or more communication interface modules; and a processor which executes the program stored in the memory. Herein, when the program is executed, the processor receives a setting parameter required to start searching for a wireless LAN access point through a virtualization layer and sets an operation parameter according to the received setting parameter.

Further, in accordance with yet another aspect of the present disclosure, a mobile device may include: a first communication module operating as a primary communication module; and a second communication module operating as a secondary communication module. Therefore, when the first communication module performs a handover from a source base station to a target base station, the second communication module receives a data packet from the source base station.

Furthermore, in accordance with still another aspect of the present disclosure, a wireless network system for providing a wireless communication service to a mobile device may include: a radio access network including a macro base station or a small cell base station; and a core network including a mobile management entity and a core network gateway. Herein, at the mobile management entity, the mobile device is attached as including a primary communication module and a secondary communication module. Further, when the primary communication module in the mobile device performs a handover from a source base station to a target base station, the secondary communication module receives a data packet from the source base station.

Moreover, in accordance with still another aspect of the present disclosure, a method for providing a wireless communication service to a mobile device may include: attaching a mobile device as including a primary communication module and a secondary communication module at a mobile management entity of a wireless network system; requesting, by the mobile device, a packet redirection from the mobile management entity; instructing, by the mobile management entity, a core network gateway of the wireless network system to perform a packet redirection; setting a bearer and a base station to transfer a packet to the secondary communication module in response to the request for packet redirection and transferring the packet to the set base station by the core network gateway; and receiving the packet by the secondary communication module of the mobile device.

Further, in accordance with still another aspect of the present disclosure, a handover method of a mobile device in a wireless network system may include: performing a handover from a source base station to a target base station by a primary communication module of a mobile device; and receiving a data packet from the source base station by a secondary communication module at the same time when the primary communication module of the mobile device performs the handover.

### Effects of the Invention

According to any one of the above-described aspects of the present disclosure, a mobile device acquires mobility information of the mobile device from a base station. Therefore, the mobile device on the move can autonomously determine whether to start searching for a wireless LAN access point and thus more efficiently search a wireless LAN.

Further, according to any one of the aspects of the present disclosure, a mobile device on the move autonomously determines whether to start searching for a wireless LAN access point. Therefore, it is possible to save battery power and also possible to reduce traffic congestion in a mobile communication network.

Furthermore, according to any one of the aspects of the present disclosure, it is possible to reduce a handover delay of a wireless network system.

Moreover, according to any one of the aspects of the present disclosure, a mobile device can continuously maintain data communication with a source base station while performing a handover to a target base station. Therefore, it is possible to reduce a service interruption occurring when performing a handover.

Further, according to any one of the aspects of the present disclosure, two communication modules are used and the respective communication modules use a data plane and a control plane. Therefore, a configuration is simple, and the respective communication modules can independently operate.

Furthermore, according to any one of the aspects of the present disclosure, two communication modules can independently operate and also independently transmit/receive data. Therefore, it is possible to distribute user traffic and thus distribute a load.

### BRIEF DESCRIPTION OF THE DRAWINGS

FIG. 1 illustrates a system supporting a method for searching a wireless LAN by a mobile device to which an exemplary embodiment of the present disclosure is applied;

FIG. 2 is a detailed diagram provided to specifically describe a process for transferring information in a wireless network system supporting a method for searching a wireless LAN by a mobile device in accordance with an exemplary embodiment of the present disclosure;

FIG. 3 is a detailed diagram illustrating a method for searching a wireless LAN by a mobile device to which a trigger timer is applied in a method for searching a wireless LAN by a mobile device in accordance with an exemplary embodiment of the present disclosure;

FIG. 4 is a configuration diagram illustrating a configuration of a mobile device supporting a method for searching a wireless LAN in accordance with an exemplary embodiment of the present disclosure;

FIG. 5 is a detailed diagram illustrating a process for acquiring mobility information of a mobile device supporting a method for searching a wireless LAN in accordance with an exemplary embodiment of the present disclosure.

FIG. 6 illustrates a structure of a wireless network system to which another exemplary embodiment of the present disclosure is applied;

FIG. 7 illustrates a macro cell and a small cell to which another exemplary embodiment of the present disclosure is applied;

FIG. 8 illustrates the received signal strength in the macro cell and the small cell to which another exemplary embodiment of the present disclosure is applied;

FIG. 9 illustrates an example of a wireless communication system in accordance with yet another exemplary embodiment of the present disclosure;

FIG. 10 specifically illustrates the example of the wireless communication system in accordance with yet another exemplary embodiment of the present disclosure;

FIG. 11 illustrates a communication protocol structure for attaching a dual-mode capability of a wireless communication system to which still another exemplary embodiment of the present disclosure is applied;

FIG. 12 illustrates a process of a handover delay in a wireless communication system to which still another exemplary embodiment of the present disclosure is applied;

FIG. 13 illustrates an example where a packet is continuously transferred to a mobile device while a handover is performed in accordance with still another exemplary embodiment of the present disclosure;

FIG. 14 illustrates a flow of a handover method without a service interruption in a wireless communication system to which still another exemplary embodiment of the present disclosure is applied;

FIG. 15 illustrates a flow of a method for attaching a dual-mode capability of a wireless communication system to which still another exemplary embodiment of the present disclosure is applied;

FIG. 16 illustrates a flow of a dual-mode communication method in a wireless communication system to which still another exemplary embodiment of the present disclosure is applied;

FIG. 17 illustrates a flow of an example of starting a dual-mode communication in the wireless communication system to which still another exemplary embodiment of the present disclosure is applied;

FIG. 18 illustrates a flow of an example of terminating a dual-mode communication in the wireless communication system to which still another exemplary embodiment of the present disclosure is applied; and

FIG. 19 illustrates a flow of an example of detecting a handover and a wireless LAN as a heterogeneous small cell in the wireless communication system to which still another exemplary embodiment of the present disclosure is applied.

### MODE FOR CARRYING OUT THE INVENTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements unless context dictates otherwise.

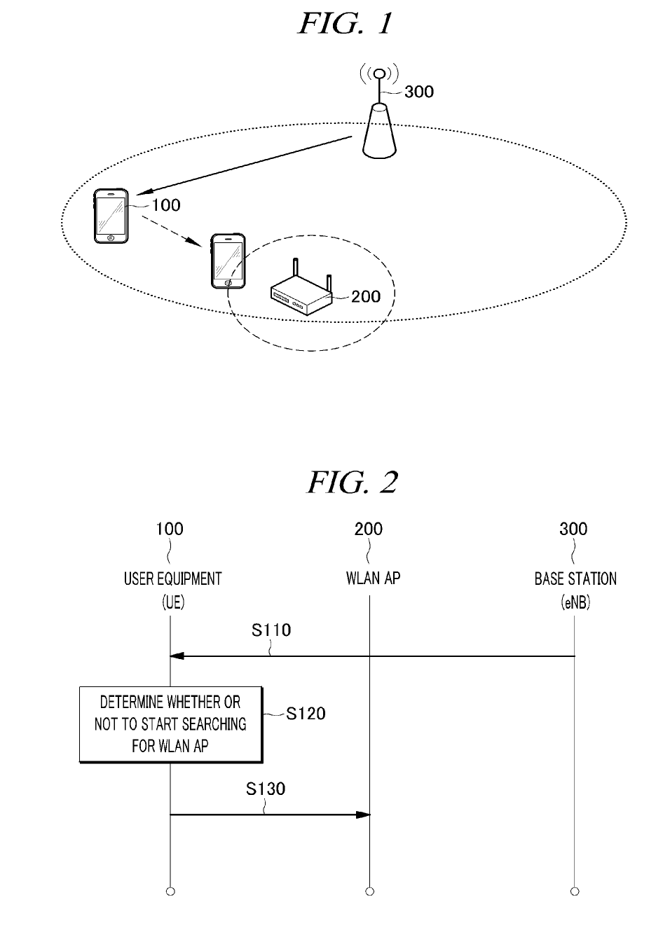

Hereinafter, a wireless network system supporting a method for searching a wireless LAN by a mobile device to which an exemplary embodiment of the present disclosure is applied will be described in detail with reference to FIG. 1.

FIG. 1 illustrates a system supporting a method for searching a wireless LAN by a mobile device to which an exemplary embodiment of the present disclosure is applied.

Referring to FIG. 1, a system supporting a method for searching a wireless LAN by a mobile device to which an exemplary embodiment of the present disclosure is applied includes a mobile device (User Equipment (UE)) 100, a WLAN access point (WLAN AP) 200, and a base station (Enhanced NodeB (eNB) or Radio Network Controller (RNC)) 300.

The UE 100 includes two kinds of wireless modules including a WLAN module and a cellular module. The UE 100 performs communication as being connected to a cellular system, searches the WLAN AP 200, accesses a WLAN by a link process, and then transmits data through the WLAN. Herein, communication with the WLAN uses a different radio frequency from the cellular system connected to the UE 100, and in order to perform a WLAN search for discovering the WLAN AP 200, a WLAN scanning process for searching another frequency band is performed.

The WLAN AP 200 typically uses a radio resource in an unlicensed band, and, thus, the cost for data communication is lower than the cost for cellular communication. Therefore, it is possible to use a method for transmitting/receiving data using a WLAN in order to reduce a load of the cellular system and process transmitted/received data of the mobile device at low cost.

The base station 300 may transfer information which can be used for searching the WLAN APs 200 accessible by the UE 100 using a communication protocol used by the base station 300 and the UE 100 for mutual communication, i.e., a communication protocol through a control plane. Further, the macro base station 300 may transfer a setting parameter required to start searching for the WLAN AP 200 to the UE 100. Herein, the setting parameter may include an installation density of WLANs, a WLAN coverage, a reference value for scanning mobility, and the like.

FIG. 2 is a detailed diagram provided to specifically describe a process for transferring information in a wireless network system supporting a method for searching a WLAN by a mobile device in accordance with an exemplary embodiment of the present disclosure.

Referring to FIG. 2, a process for transferring information in a wireless network system supporting a method for searching the WLAN AP 200 by the UE 100 in accordance with an exemplary embodiment of the present disclosure may include: receiving, by the UE 100, a setting parameter required to start searching for the WLAN AP 200; determining whether or not to start searching for the WLAN AP 200; and starting searching for the WLAN AP 200.

Firstly, in the receiving, by the mobile device, a setting parameter required to start searching for the WLAN AP (s110), the base station 300 transfers the setting parameter required to start searching for the WLAN AP 200 to the UE 100, and the UE 100 receives the setting parameter required to start a search. Herein, the setting parameter required to start a search may include an installation density of WLANs, a WLAN coverage, a reference value for scanning mobility, and the like. Herein, the reference value for scanning mobility means a reference value used to determine that if a movement speed of the UE 100 is higher than the reference value for scanning mobility, scanning is not performed, and at the time when a movement speed of the UE 100 becomes lower than the reference value for scanning mobility, a search for the WLAN AP 200 is started. The reference value may be selected using movement speed statistics of a user.

Then, in the determining whether or not to start searching for the WLAN AP (s120), the UE 100 determines whether or not to start searching for the WLAN AP 200 on the basis of the setting parameter received from the base station 300. Herein, when the UE 100 determines whether or not to start searching for the WLAN AP 200, a movement speed of the UE 100 is measured and if the movement speed is higher than the reference value for scanning mobility, a search for the WLAN AP 200 is delayed and at the time when the movement speed of the UE 100 becomes lower than the reference value for scanning mobility, a the search for the WLAN AP 200 is started.

The method of measuring the movement speed of the UE 100 may include a method using a Doppler shift, a method of counting the number of handovers, a method using the strength of a received signal, or a method using a GPS.

Firstly, in the method using a Doppler shift, the correlation of a frequency measured by the UE 100 on the move with an originally transmitted frequency and a movement speed is used and can be expressed by the following Equation 1.

$$f = ( \frac{c + {v}_{r}}{c + {v}_{s}} ) {f}_{0} \qquad [ Equation 1 ]$$

Herein, f is an observed frequency, c is a speed of a wave, and vᵣ and vₛ are a relative speed of a receiver and a relative speed of a source, respectively. Further, f₀ is a transmission frequency.

Further, in the method for searching a WLAN in accordance with an exemplary embodiment of the present disclosure, the mobility of the base station 300 is not considered. Therefore, Equation 1 can be arranged into Equation 2, and vᵣ can be measured using Equation 2. Herein, Equation 2 is as follows.

$$f = ( \frac{c + {v}_{r}}{c} ) {f}_{0} \qquad [ Equation 2 ]$$

Meanwhile, the method of counting the number of handovers may use a handover performed when the UE 100 moves and changes a cell. To be specific, a speed is measured by counting the number of handovers performed while the mobile device moves. Herein, if there is a great number of handovers, it may be determined that a speed is high. Further, a handover is relevant to a cell size, and, thus, the number of handovers may be acquired by negotiation with the base station 300. Furthermore, if there is a small cell, which does not perform a handover, within the base station 300, the number of small cells observed by measurement may be counted. Otherwise, a movement speed may be measured by consecutively measuring a time between the moment when a signal of a small cell is detected and the moment when the signal of the small cell disappears.

Otherwise, since all of electromagnetic waves including wireless signals are attenuated in reverse proportion to a distance while being propagated, a movement speed may be measured using the strength of a received signal. The strength of a signal is attenuated in reverse proportion to the square of a distance in a free space. Therefore, if the strength of a received signal is measured, it is possible to know a distance from the base station 300. Therefore, a movement distance may be measured by consecutively measuring signal qualities of the base station at an interval of time, so that a speed may be calculated.

Finally, in the method using a GPS, a reference value for a movement speed is determined by a WLAN coverage. By way of example, if a WLAN coverage is 100 m and a movement speed is 50 km/h, a mobile device moves at about 14 m per second, and, thus, exceeds the coverage in about 7 seconds. In this case, even if a WLAN is searched, it is impossible to access the WLAN. Therefore, it is useless to perform a search. If a movement speed is 5 km/h, a mobile device moves at about 1.4 m per second, and, thus, stays in the coverage for about 70 seconds. Therefore, the preference for a retention time in the coverage suitable for access may be set by manual input from the user. Further, the reference value for scanning mobility can be set together with an installation density of WLANs or WLAN coverage information transmitted by the base station 300.

Then, in the starting searching for the WLAN AP (s130), if the received parameter satisfies a condition for starting a search, the UE 100 may start searching for the WLAN AP 200. However, if the received parameter does not satisfy the condition for starting a search, the search is delayed.

Meanwhile, the method for searching a WLAN by a mobile device in accordance with an exemplary embodiment of the present disclosure may use a trigger timer. Herein, the UE 100 may set an activation time of the trigger timer while starting a movement. A set-up time of the trigger timer may be set to, for example, the time to reach a destination by calculating a movement distance of a mover and a speed of a means of transportation. Therefore, when the activation of the trigger timer is expired, the UE 100 may compare the movement speed with the reference value for scanning mobility.

In other words, while the trigger timer is activated, the UE 100 does not start searching for the WLAN AP 200. However, if the movement speed of the UE 100 is lower than the reference value for scanning mobility at the time when the activation of the trigger timer is expired, the UE 100 starts searching for the WLAN AP 200. Otherwise, if the movement speed of the UE 100 is higher than the reference value for scanning mobility at the time when the activation of the trigger timer is expired, the trigger timer is activated for a preset time and then expired.

By way of example, in the case of using public transportation, the user may need to search a WLAN in a bus or a train. Typically, there is a time for waiting public transportation without any mobility in order to use public transportation, and then, a movement is made while getting on the public transportation. In accordance with an exemplary embodiment of the present disclosure, if the movement is made, the trigger timer can be activated. However, when the activation of the trigger timer is expired, the movement may be continued or a speed of a moving object may be equal to or higher than a reference value for mobility. Therefore, according to the method for searching a WLAN by a mobile device in accordance with an exemplary embodiment of the present disclosure, if public transportation with mobility is used after selective absence of mobility, a reference value for mobility is not checked for the first round after activation of the trigger timer is expired. Therefore, a WLAN AP present in a moving object is discovered and access is made. This operation enables the user to set a selection mode and perform a selective operation in the mobile device.

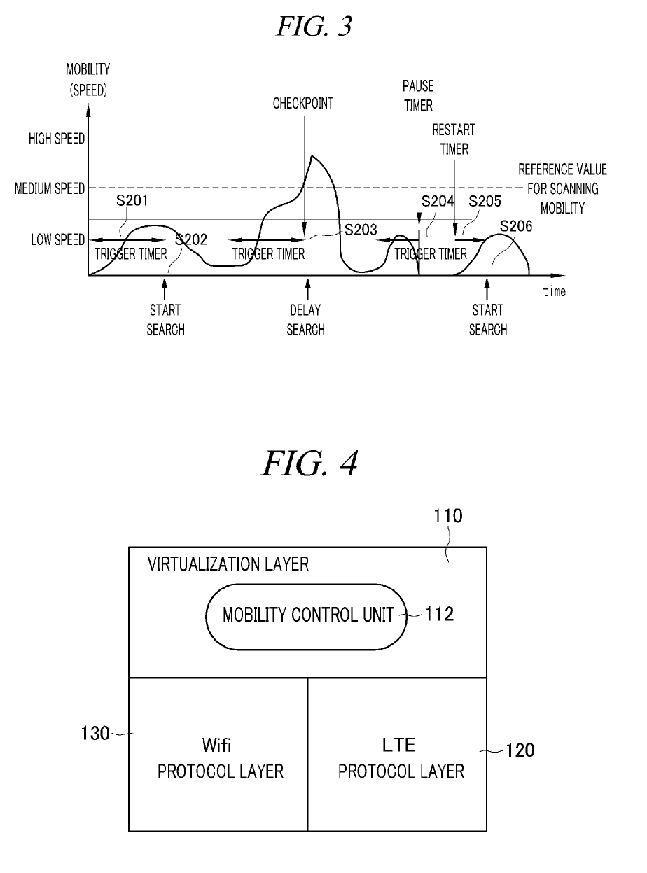

FIG. 3 is a detailed diagram illustrating a method for searching a WLAN by a mobile device to which a trigger timer is applied in a method for searching a WLAN by a mobile device in accordance with an exemplary embodiment of the present disclosure.

As illustrated in FIG. 3, the UE 100 sets an activation time of the trigger timer while starting a movement (S201).

The trigger timer may be activated when the UE 100 starts a movement. Then, when the activation of the trigger timer is expired, the UE 100 compares a movement speed of the UE 100 with a reference value for scanning mobility. Herein, if the movement speed of the UE 100 is lower than the reference value for scanning mobility, the UE 100 starts searching for the WLAN AP 200 (S202).

On the other hand, when the activation of the trigger time is expired, if the movement speed of the UE 100 is higher than the reference value for scanning mobility, the UE 100 may delay a search for the WLAN AP 200 (S204). Further, if the search for the WLAN AP 200 is delayed due to the movement speed of the UE 100, the UE 100 may reactivate the expired trigger timer into a checkpoint-activated state.

If the trigger timer is reactivated into the checkpoint-activated state, the trigger timer has regular checkpoints, and compares a movement speed of the UE 100 with a reference value for scanning mobility at each checkpoint time to determine whether or not to start searching for the WLAN AP 200.

Further, while the trigger timer operates, if the UE 100 stops a movement, the trigger timer may be temporarily stopped (s204). Herein, the remaining activation time may be recorded by the UE 100, and when the UE 100 restarts a movement, the trigger timer may also be activated (s205). Then, if the UE 100 restarts a movement, the trigger timer is activated for the remaining time and then expired. If the trigger timer is activated for the preset activation time and then expired, the UE 100 starts searching for the WLAN AP 200 (s206).

Hereinafter, a configuration of a mobile device supporting a method for searching a WLAN in accordance with an exemplary embodiment of the present disclosure will be described in detail with reference to FIG. 4.

FIG. 4 is a configuration diagram illustrating a configuration of a mobile device supporting a method for searching a WLAN in accordance with an exemplary embodiment of the present disclosure.

Referring to FIG. 4, a mobile device supporting a method for searching a WLAN in accordance with an exemplary embodiment of the present disclosure may include a virtualization layer 110, a LTE protocol layer 120, and a WiFi protocol layer 130. Herein, the virtualization layer 110 may include a mobility control unit 112.

Firstly, the virtualization layer 110 may make a request to the LTE protocol layer 120 to transfer mobility information and receives the mobility information from the LTE protocol layer 120. Herein, the virtualization layer 110 may request a transfer of mobility information as necessary or may request a transfer of mobility information one time and then receive mobility information whenever a mobility event occurs. Herein, the virtualization layer 110 communicates with another layer through a service access point (SAP), and the SAP may perform communication using a message in a primitive form. In other words, an installation density of WLANs, a WLAN coverage, a reference value for scanning mobility (movement speed to start scanning), and the like received as LTD parameters are transferred to the virtualization layer 110 as a message in a primitive form.

Further, the virtualization layer 110 may include the mobility control unit 112. Herein, the mobility control unit 112 sets an operation parameter according to the parameter received from the LTE protocol layer 120.

Meanwhile, in the mobile device supporting a method for searching a WLAN in accordance with an exemplary embodiment of the present disclosure, the mobility control unit 112 may include a trigger timer. Herein, the mobility control unit 112 may set an activation time of the trigger timer while starting a movement. Further, if the trigger timer satisfies a condition for starting a WLAN search, the mobility control unit 112 may give an instruction to search for a WLAN. Otherwise, the instruction to search for a WLAN may be given from a separate device instead of the mobility control unit 112.

Then, the LTE protocol layer 120 may include a WLAN data link layer (LTE MAC) and a WLAN physical layer (LTE PHY). Herein, the LTE MAC may refer to a combination of Radio Resource Control, Radio Link Control, and Medium Access Control of 3GPP LTE.

The LTE protocol layer 120 may observe mobility of the UE 100, and may transfer mobility information to the virtualization layer 110 whenever a movement or stop event occurs.

Further, the WiFi protocol layer may include a WLAN data link layer (WiFi MAC) and a WLAN physical layer (WiFi PHY). Herein, the WiFi protocol layer receives the instruction to search for a WLAN from the virtualization layer 110 and performs a WLAN search.

For reference, each of components illustrated in FIG. 4 in accordance with an exemplary embodiment of the present disclosure may imply software or hardware such as a field programmable gate array (FPGA) or an application specific integrated circuit (ASIC), and they carry out a predetermined function.

However, the “components” are not limited to the software or the hardware, and each of the components may be stored in an addressable storage medium or may be configured to implement one or more processors.

Accordingly, the components may include, for example, software, object-oriented software, classes, tasks, processes, functions, attributes, procedures, sub-routines, segments of program codes, drivers, firmware, micro codes, circuits, data, database, data structures, tables, arrays, variables and the like.

The components and functions thereof can be combined with each other or can be divided up into additional components.

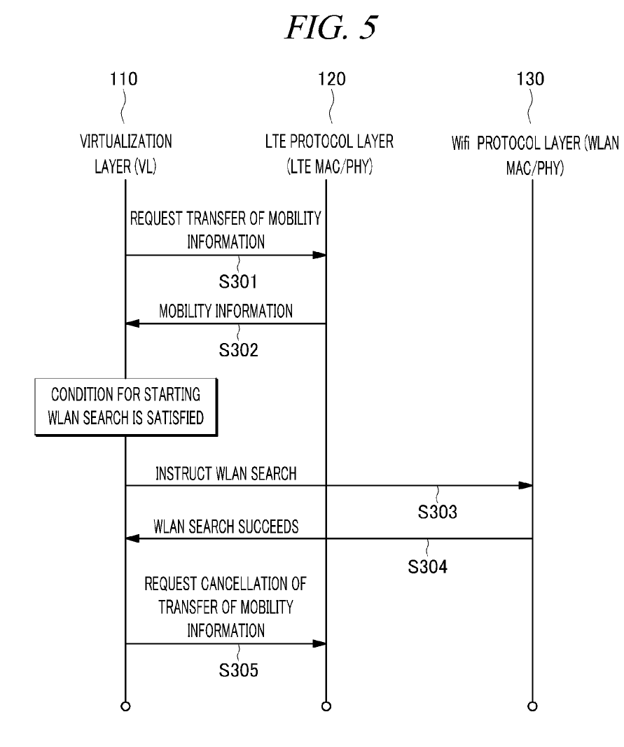

FIG. 5 is a detailed diagram illustrating a process for acquiring mobility information of a mobile device supporting a method for searching a WLAN in accordance with an exemplary embodiment of the present disclosure.

Referring to FIG. 5, in a process for acquiring mobility information of a mobile device supporting a method for searching a WLAN in accordance with an exemplary embodiment of the present disclosure, firstly, the virtualization layer 110 may request mobility information required to start searching for the WLAN AP 200 from the LTE protocol layer 120 (s301). Then, the LTE protocol layer 120 may transfer mobility information depending on whether or not an event occurs to the virtualization layer 110 (s302). Then, the virtualization layer 110 may determine whether the mobility information satisfies a condition for starting a search for a WLAN. If the mobility information satisfies the condition for starting a WLAN search, the virtualization layer 110 may give an instruction to search for a WLAN to the WiFi protocol layer 130 (s303). Further, if the WLAN search is successfully performed, the WiFi protocol layer 130 may deliver information about whether or not the WLAN search is successfully performed to the virtualization layer 110 (s304). Then, the virtualization layer 110 may make a request to the LTE protocol layer 120 to cancel the transfer of mobility information.

Meanwhile, when the virtualization layer 110 requests mobility information required to start searching for the WLAN AP 200 from the LTE protocol layer 120 (s301), the virtualization layer 110 may request a transfer of mobility information as necessary or may request a transfer of mobility information one time and then receive mobility information whenever a mobility event occurs. The request for a transfer of mobility information may be made when it is necessary to access a WLAN. A WLAN access operation may be set manually by the user or automatically by the mobility control unit 112.

Then, when the LTE protocol layer 120 transfers mobility information depending on whether or not an event occurs to the virtualization layer 110 (s302), the LTE protocol layer 120 may receive a request for a transfer of mobility information from the virtualization layer 110 and observe mobility of the UE 100. Further, the LTE protocol layer 120 may transfer mobility information to the virtualization layer 110 whenever a movement or stop event occurs.

To be specific, if the UE 100 starts a movement, the LTE protocol layer 120 may transfer movement information including a movement start time, a movement direction, and a movement speed to the virtualization layer 110. Further, if a stop event occurs, the LTE protocol layer 120 may transfer stop information to the virtualization layer 110. Herein, the stop information may include a stop time or the duration from start to stop of a movement, and a movement direction. This operation may be continued whenever a movement or stop event occurs. The information including an installation density of WLANs, a WLAN coverage, and a reference value for scanning mobility (movement speed to start scanning) received from the base station 300 may also be transferred.

If the virtualization layer 110 receives the mobility information from the LTE protocol layer 120, the mobility control unit 112 of the virtualization layer 110 may determine whether or not to start a search for the WLAN AP 200 on the basis of the mobility information transferred from the LTE protocol.

In a device for searching a WLAN in accordance with an exemplary embodiment of the present disclosure, the mobility control unit 112 may include a trigger timer. Herein, the mobility control unit 112 may control an operation of the trigger timer. To be specific, if the UE 100 starts a movement, the mobility control unit 112 may activate the trigger timer. Then, when the activation of the trigger timer is expired, the mobility control unit 112 may compare a movement speed of the UE 100 with a reference value for scanning mobility. Herein, if the movement speed of the UE 100 is higher than the reference value for scanning mobility, the virtualization layer 110 may give an instruction to the WiFi protocol layer 130 to delay a search for the WLAN AP 200. However, if the movement speed of the UE 100 is lower than the reference value for scanning mobility, the virtualization layer 110 may give an instruction to the WiFi protocol layer 130 to perform a search for the WLAN AP 200 (s303).

If the WiFi protocol layer 130 receives the instruction to perform a search for the WLAN AP 200 from the virtualization layer 110, the WiFi protocol layer 130 starts searching the WLAN AP 200. Further, if the WLAN search is successfully performed, the WiFi protocol layer 130 may deliver information about whether or not the WLAN search is successfully performed to the virtualization layer 110 (s304).

Then, after receiving the information about whether or not the WLAN search is successfully performed from the WiFi protocol layer 130, the virtualization layer 110 may make a request to the LTE protocol layer 120 to cancel the transfer of mobility information (s305).

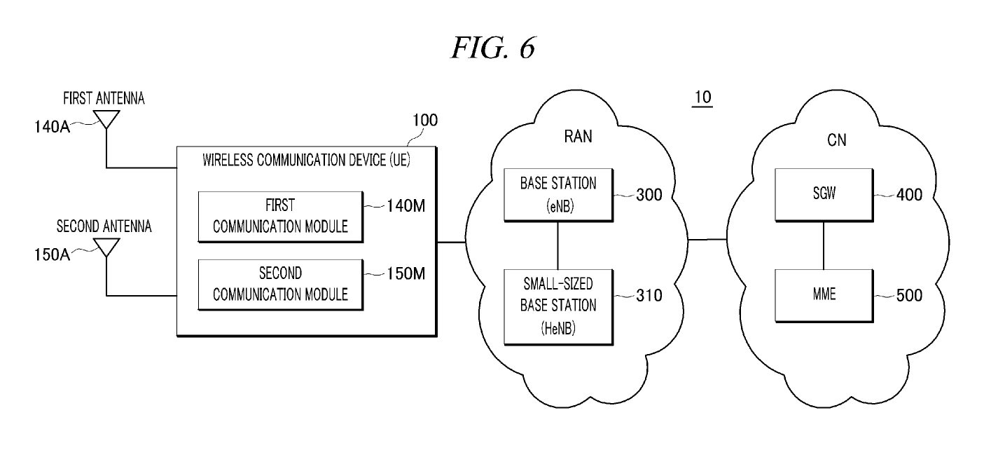

FIG. 6 illustrates a structure of a wireless network system to which another exemplary embodiment of the present disclosure is applied.

Referring to FIG. 6, a wireless network system 10 to which another exemplary embodiment of the present disclosure is applied may include a core network CN as a central part of the network and a radio access network RAN. Herein, the radio access network may be an access network that connects the UE 100 using a RF signal.

Further, the wireless network system 10 in accordance with an exemplary embodiment of the present disclosure may be configured to comply with various wireless communication standards. By way of example, the wireless network system 10 may comply with the LTE-A (Long Term Evolution-Advanced) standards, but may not be limited thereto.

Furthermore, the core network CN may include a serving gateway (SGW) 400 and mobile management entity (MME) 500. The MME 500 is a critical component of the core network CN in charge of various control functions to provide a wireless communication function of the UE 100. Further, the SGW 400 functions as a router that forwards a user data packet. Therefore, in the following, the MME 500 will be referred to as “MME” or “mobile management entity”, and the serving gateway 400 will be referred to as “SGW” or “core network gateway”.

Moreover, the core network CN may be connected to an external network or the Internet through a PGW (Packet Data Network Gateway (PDN Gateway): not illustrated) or the like. Accordingly, the UE 100 can be provided with cellular communication and various Internet services provided by the wireless network system 10.

In an exemplary embodiment of the present disclosure, the UE 100 is called various names such as a mobile device, a portable device, a user device, and a user equipment (UE), and refers to a device capable of using a wireless communication function provided by the wireless network system 10.

The UE 100 in accordance with an exemplary embodiment of the present disclosure includes a first communication module 140M and a second communication module 150M, and may provide a dual-mode communication function using these modules. The UE 100 may further include a first antenna 140A and a second antenna 150A connected to the respective communication modules, but may not be limited thereto. That is, the UE 100 may include one or more antennas. Further, the first communication module 140M and the second communication module 150M of the UE 100 may operate in different frequency bands (different frequency allocations (FAs)).

Meanwhile, the radio access network RAN may include one or more base stations (eNB) 300 and may further include a small-sized base station (HeNB) 310. Herein, the base station 300 may be a transceiver system including all of base stations (BS), relay stations, and the like, and may be called various names such as a cellular network base station and a wireless base station. Therefore, in the present specification, the base station 300 may be referred to as “eNB (Evolved Node B (eNodeB))”, but may not be limited to the scope of the term. The base station 300 may serve or cover a macro cell (MC). Therefore, in the present specification, the base station 300 may also be referred to as “macro base station 300”.

Meanwhile, the small-sized base station 310 is a small base station that has lower power and a smaller coverage (service area) than the macro base station. In the present specification, the small-sized base station 310 may be referred to as “HeNB (Home Evolved Node B (eNodeB)), but may not be limited to the scope of the term. The small-sized base station 310 may serve or cover a small cell (SC), and the small cell may be, for example, a femtocell. Therefore, in the present specification, the small-sized base station 310 may also be referred to as a small cell base station 310. However, in the present specification, when referred to as “base station” without being specified as the small-sized base station 310, the base station may imply the base stations 300 and 310 including the small-sized base station 310.

Recently, small cells have been employed more and more due to their advantages of being able to extend a coverage of a wireless cellular network at low cost and reduce a traffic load of the wireless cellular network. However, in order to do so, the interference problem or the handover delay problem needs to be solved.

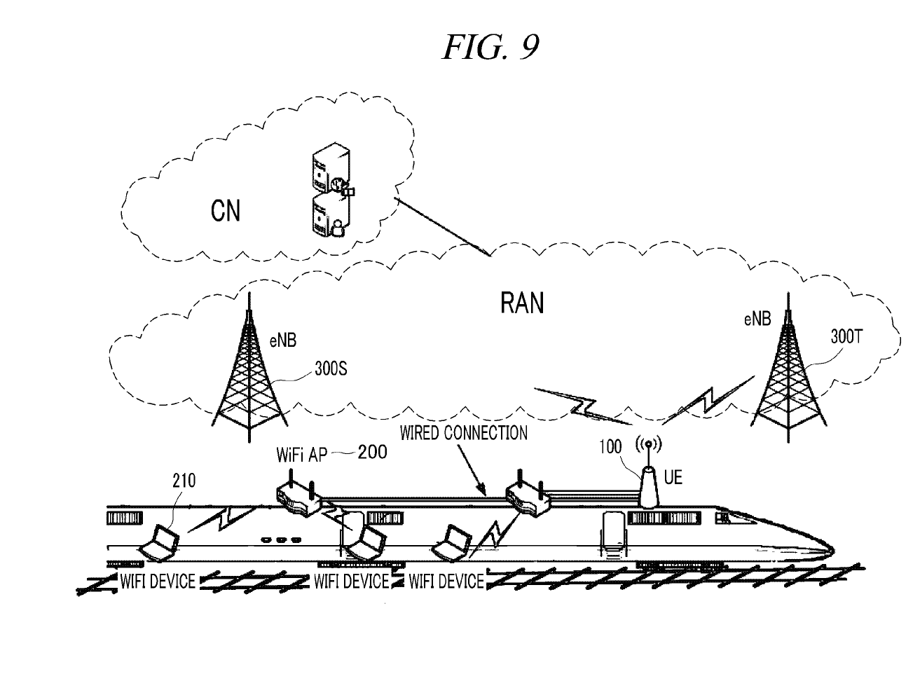

The UE 100 on the move resets a connection to other base stations 300 and 310 having stronger signals in order to keep the connection to the radio access network RAN, which is called “handover”. Meanwhile, a service interruption may be caused by a handover delay to be described with reference to FIG. 9. However, since a delay occurring at the time of handover with respect to a small cell is longer than a delay occurring at the time of handover between macro cells, a service interruption is more likely to occur at the time of handover with respect to a small cell.

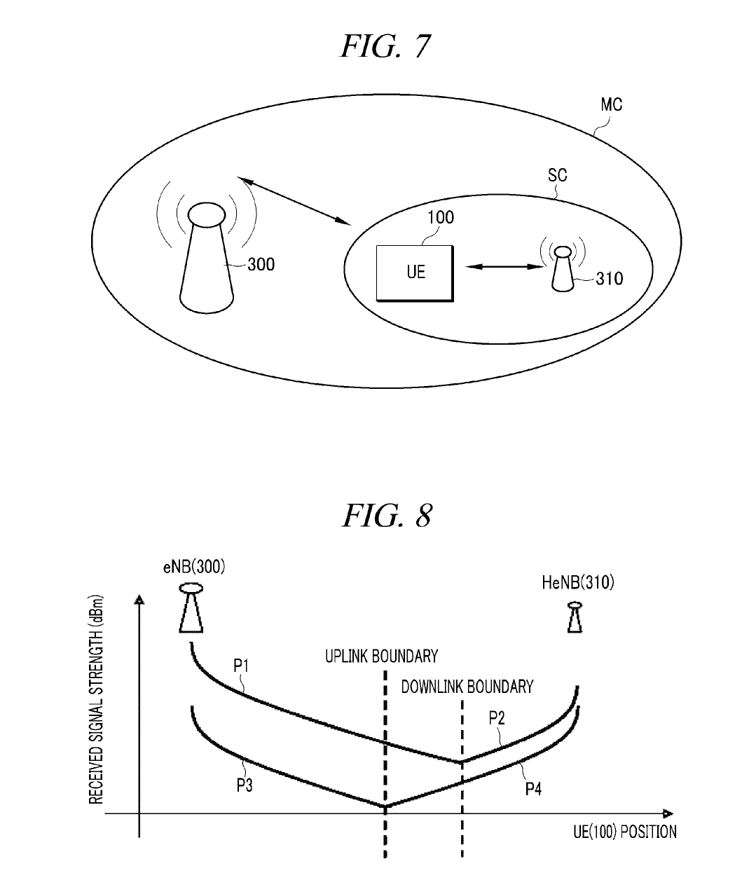

Hereinafter, a macro cell and a small cell will be described in more detail with reference to FIG. 7 and FIG. 8.

FIG. 7 illustrates a macro cell and a small cell to which another exemplary embodiment of the present disclosure is applied, and FIG. 8 illustrates the received signal strength in the macro cell and the small cell to which another exemplary embodiment of the present disclosure is applied.

As illustrated in FIG. 7, the UE 100 may transmit/receive wireless signals to/from the base station 300 and the small-sized base station 310. The small cell SC has a smaller coverage than the macro cell MC. As illustrated in FIG. 7, if the small cell SC is present within the macro cell MC (overlay), the wireless network system 10 may allow the small cell SC, instead of the macro cell MC, to provide a wireless communication service to the UE 100 (off-load) and thus may reduce a traffic load of the macro cell MC.

Further, if the macro cell MC and the small cell SC are configured to be overlaid with each other, the UE 100 may receive data from both sides at the same time or may selectively receive data from any one side. Further, the macro cell MC and the small cell SC may be interworked by an interface, such as an X2 interface, interworked between macro cells MCs.

Meanwhile, the macro cell MC and the small cell SC may be configured to use different carrier frequencies or may be configured to use the same carrier frequency. Each of the two configurations has advantages and disadvantages.

By way of example, if the macro cell MC uses one frequency and the small cell SC uses the other frequency, the interference problem caused by an influence between the two carrier frequencies may be less serious. However, in order to detect the small cell SC using the other frequency, a service interruption may occur in the macro cell MC. Further, a service interruption may occur during handover and the spectral efficiency may be decreased.

If the macro cell MC and the small cell SC share two frequencies according to the carrier aggregation (CA) technology, it is complicated to perform an operation. However, it is easy to detect the cell and it is possible to efficiently use resources.

FIG. 8 is a diagram illustrating transmit/receive distances of the macro cell MC and the small cell SC, and shows that the strength of a received signal is attenuated according to the position of the UE 100.

Referring to FIG. 8, a section P1 shows the strength of a downlink signal received from the macro base station 300, and a section P2 shows the strength of a downlink signal received from the small-sized base station 310. Further, a section P3 shows the strength of an uplink signal received by the macro base station 300, and a section P4 shows the strength of an uplink signal received by the small-sized base station 310.

As illustrated in FIG. 8, a data transmission speed is decreased from a central area of a cell toward a boundary area of the cell due to attenuation of a wireless signal according to a distance. Therefore, as described above, if the UE 100 on the move becomes far away from the base station from which a service is currently provided, the UE 100 performs a handover to another base station having a more favorable strength of the signal which the mobile device currently receives.

Further, as described above, if the small-sized base station 310 is established at lower cost than the macro base station 300 which costs a lot, it is possible to extend the total coverage.

Generally, when base stations are established, a cell service coverage provided by each base station is configured to be overlaid with each other. Herein, since the small cell SC has a shorter transmission distance than the macro cell MC, a method of detecting the small cell SC needs to be different from a method of detecting the macro cell MC. Therefore, if the small cell SC is searched and a handover is performed in the same manner as a handover between the macro cells MCs, a service interruption may occur.

The above-described service interruption caused by the handover may frequently occur particularly in the case of using a moving object such as a car or a high-speed train. Accordingly, if the user of the UE 100 wants to be provided with a wireless communication service while getting on the moving object moved at a high speed as shown in the environment illustrated in FIG. 9, it becomes difficult for the user to be readily provided with the wireless communication service.

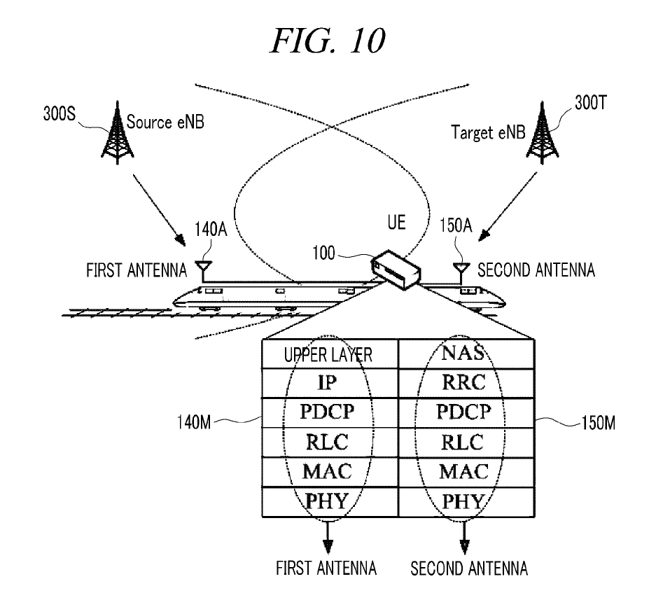

FIG. 9 and FIG. 10 illustrate an example of a wireless communication system in accordance with yet another exemplary embodiment of the present disclosure.

Referring to FIG. 9, a wireless communication system to which yet another exemplary embodiment of the present disclosure is applied may perform cellular mobile communication such as LTE by establishing an on-board terminal in a train as a moving object. Herein, the UE 100 is an on-board terminal, and may be used to provide a passenger with a WLAN service such as WiFi. That is, the UE 100 to which yet another exemplary embodiment of the present disclosure is applied is an on-board terminal to access a cellular network (RAN), and may be used to provide WiFi which is a heterogeneous wireless network. In order to do so, the UE 100 may be connected to one or more WLAN APs (WiFi Access Points) in a wired manner, and the WLAN AP 200 may transmit/receive wireless communication signals to/from a WiFi device 210. Herein, the radio access network RAN and the core network CN connected to the UE 100 are the same as illustrated in FIG. 6. Therefore, the WiFi device 210 of the user can be connected to the Internet.

To be specific, the WiFi device 210 may transmit a packet as being connected to the WLAN AP 200 accessible from its position. Herein, the WiFi device 210 may transmit packets transferred from the WLAN AP 200 to an Internet network by the same method as the method of cellular communication of the UE 100 with the cellular base station. Further, the same applies to the packets in the opposite direction. That is, a packet from a network is transmitted from the cellular base station 300 to the UE 100, and the UE 100 transfers the packet to the WLAN AP 200 connected thereto in a wired manner. Then, the WLAN AP 200 transfers the packet to the WiFi device 210 via a WLAN, so that the WiFi device 210 can receive the packet from the Internet network.

However, as described above, when the moving object moves at a high speed, the UE 100 becomes far away from a source base station 300S, which provides a cellular communication service, at a high speed. Therefore, since the UE 100 becomes far away from one source base station 300S, a wireless signal quality deteriorates, and the UE 100 moves toward an adjacent base station which provides a cellular communication service. Then, when a wireless signal quality of the adjacent base station is improved, a handover is performed to set a connection to the adjacent base station.

Hereinafter, in the present specification, the base station 300 or 310 from which the UE 100 is currently provided with a service will be referred to as “Source eNB” or “source base station 300S”, and the adjacent base station 300 or 310 from which the UE 100 wants to be newly provided with a service after handover will be referred to as “Target eNB” or “target base station 300T”.

As described above, it takes a predetermined time to complete a handover process, and if a moving object moves at an excessively high speed, a service interruption may occur. Therefore, in order to solve this problem, the UE 100 to which an exemplary embodiment of the present disclosure is applied may include the two communication modules 140M and 150M and the antennas 140A and 150A respectively installed on the front and back sides of the car.

Therefore, the UE 100 may perform a handover to the target base station 300T through the second antenna 150A installed on the front side of the car while transmitting/receiving data to/from the source base station 300S through the first antenna 140A installed on the back side of the car.

This configuration makes it possible to transmit/receive data while performing a handover, and, thus, has the advantage of being able to provide the WiFi device 210 of the user with a WLAN service without a service interruption.

FIG. 10 illustrates an example of a protocol layer of the first communication module 140M and the second communication module 150M to which yet another exemplary embodiment of the present disclosure is applied.

As illustrated in FIG. 10, the UE 100 may include two or more communication modules and perform a handover while communicating with the source base station 300S or the target base station 300T. Herein, the UE 100 may communicate with the source base station 300S using a data plane of the first communication module 140M. Further, the UE 100 may communicate with the target base station 300T using a control plane of the second communication module 150M.

Further, the second communication module 150M of the UE 100 may transmit/receive a message for performing a control plane handover to/from the target base station 300T through the antenna 150A installed at the head of the train. At the same time, the first communication module 140M may transmit/receive data plane data to/from the source base station 300S through the antenna 140A installed at the end of the train.

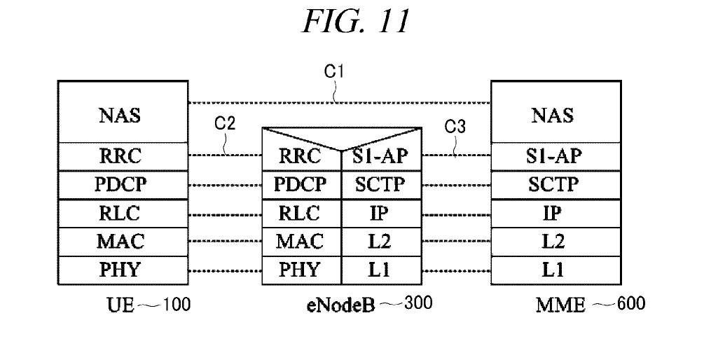

Herein, each of the data plane and the control plane may commonly include a physical (PHY) layer and a medium access control (MAC) layer corresponding to first and second layers L1 and L2 of an OSI protocol stack. Further, the second to third layers L2 and L3 of the data plane may include an Internet Protocol (IP) layer, a Packet Data Convergence Protocol (PDCP) layer, and a Radio Link Control (RLC) layer, and the control plane may include a Radio Resource Control (RRC) layer, a PDCP layer, and a RLC layer. Furthermore, the data plane may include upper layers for data communication, and the control plane may include a Non-Access Stratum (NAS) layer (see FIG. 11).

Meanwhile, as described above, in order to use the first communication module 140M and the second communication module 150M at the same time, a dual-mode capability of the UE 100 needs to be attached at the MME 500 of the core network CN.

FIG. 11 illustrates a communication protocol structure for attaching a dual-mode capability of a wireless communication system to which still another exemplary embodiment of the present disclosure is applied.

In accordance with an exemplary embodiment of the present disclosure, the UE 100 including two or more communication modules 140M and 150M needs to change a route of an IP packet in a network according to a communication condition of the UE 100.

Therefore, the network CN needs to recognize that the UE 100 is a device including two or more communication modules 140M and 150M. Capability negotiation of the UE 100 is performed by communication between NAS layers.

FIG. 11 illustrates a structure diagram of a protocol for communication with a NAS layer. The UE 100 communicates with the base station 300 on a control plane C2 of a wireless interface, and the base station 300 communicates with the MME 500 present in the network CN through an interface C3 typically constituted by wires.

The NAS is a function layer present between the core network CN and the UE 100 in the protocol stack of the wireless network system 10 such as UMTS or LTE. The NAS manages communication session setup, and keeps communication even if the UE 100 is moved. Further, the NAS is a function layer corresponding to an Access Stratum (AS) layer in charge of transmitting/receiving data. Explicit communication is performed between the UE 100 and the radio access network RAN, whereas the AS may transparently passes through the radio access network RAN between the UE 100 and the MME 500 as illustrated in FIG. 11 (C1).

At the time of initial attachment with the NAS, if the UE 100 is a device having a communication capability using two or more communication modules 140M and 150M, each of the two communication modules 140M and 150M performs an attachment process. Further, it is possible to negotiate with the NAS about which communication modules are bound to operate. Further, it is possible to negotiate about which one of the two communication modules is a primary module and which one is a secondary module.

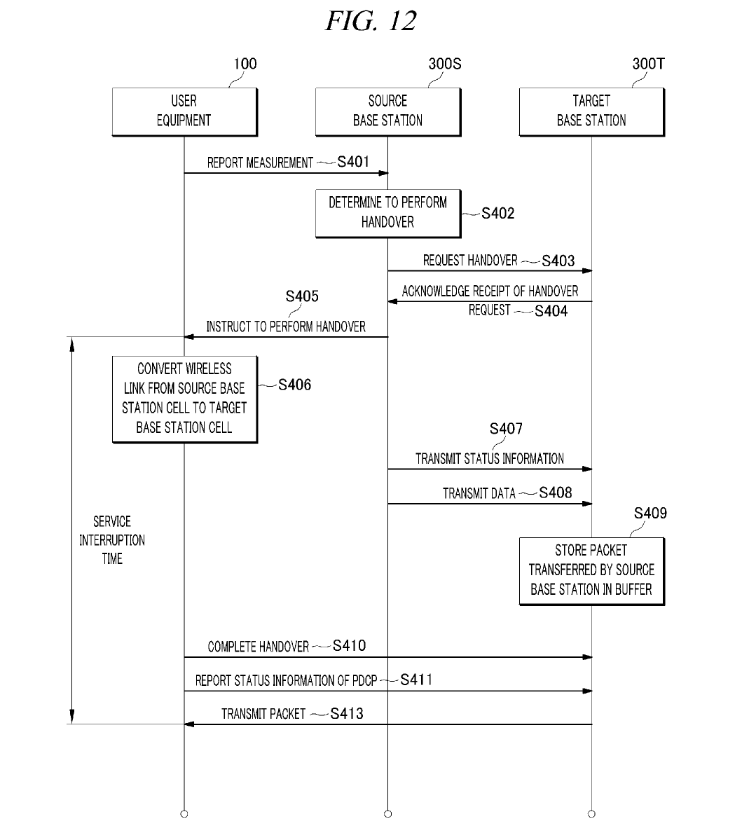

FIG. 12 illustrates a process of a handover delay in a wireless communication system to which still another exemplary embodiment of the present disclosure is applied.

Referring to FIG. 12, if a signal quality of the source base station 300S is lower than a certain reference value or less, the UE 100 measures signal qualities of the source base station 300S and a neighbor base station 200 and reports the signal qualities (S401).

Then, the source base station 300S determines whether or not to perform a handover on the basis of the report (S402).

Further, the source base station 300S performs a handover to the target base station 300T and the UE 100 (S403, S404), and gives an instruction to the UE 100 to perform a handover to the target base station 300T (S405).

The UE 100 converts a wireless link from a cell of the source base station 300S to a cell of the target base station 300T (S406). From this step, the UE 100 cannot receive a packet transferred from the source base station 300S.

Then, the source base station 300S transfers information of about a status of the UE 100 to the target base station 300T (S407).

Then, the source base station 300S may transfer data of a packet, which are stored to be transferred to the UE 100 but not transferred, to the target base station 300T (S408). The target base station 300T stores packets transferred from the source base station 300S in a buffer (S409).

Then, the UE 100 reports that access to the target base station 300T is completed (S410).

Then, the UE 100 reports the numbers of the packets, which are appropriately received from the source base station 300S, to the target base station 300T (S411).

Then, the target base station 300T transfers packets, which are stored in the buffer but not received by the UE 100, to the UE 100 (S412).

As described above, when the UE 100 on the move performs a handover to change the base station 300, a service interruption may occur (until S412 after S405). Further, as shown in the above-described exemplary embodiment, a handover occurs more frequently in a moving object such as a high-speed train moved at a high speed. Therefore, a service interruption may occur more frequently.

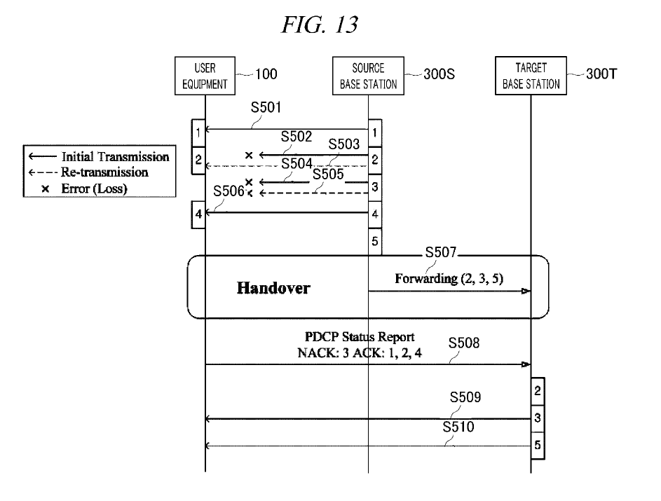

FIG. 13 illustrates an example where a packet is continuously transferred to a mobile device while a handover is performed in accordance with still another exemplary embodiment of the present disclosure. FIG. 13 shows an example where a packet is continuously transferred while a handover is performed when the source base station 300S tries to transfer packets 1, 2, 3, 4, and 5 to the UE 100.

Firstly, Packet No. 1 shows a case where the source base station 300S transfers a packet to the UE 100 without an error during initial transmission (S501).

Packet No. 2 shows a case where the source base station 300S fails to transfer a packet to the UE 100 during initial transmission (S502) and transfers a packet to the UE 100 without an error during retransmission (S503).

Packet No. 3 shows a case where the source base station 300S fails to transfer a packet to the UE 100 since an error occurs during initial transmission (S504) and retransmission (S505).

Packet No. 4 shows a case where the source base station 300S successfully transfers a packet to the UE 100 during initial transmission (S506).

Packet No. 5 shows a status where transmission is not yet started. As described above, a handover may be started in a status where some packets are not yet transferred from the source base station 300S to the UE 100.

Therefore, during a handover, the source base station 300S may transfer packets of Packet Nos. 2, 3, and 5, which are not clear whether they are successfully received by the UE 100, to the target base station 300T (S507).

Then, after the handover is successfully performed, the UE 100 reports the packets 1, 2, and 4 received without an error and the packet 3 which the UE 100 fails to receive to the target base station 300T (S508).

Therefore, the target base station 300T may transfer the packet 3 which receives NACK and the packet 5 of which transmission to the UE 100 is not started during the handover to the UE 100 (S509, S510).

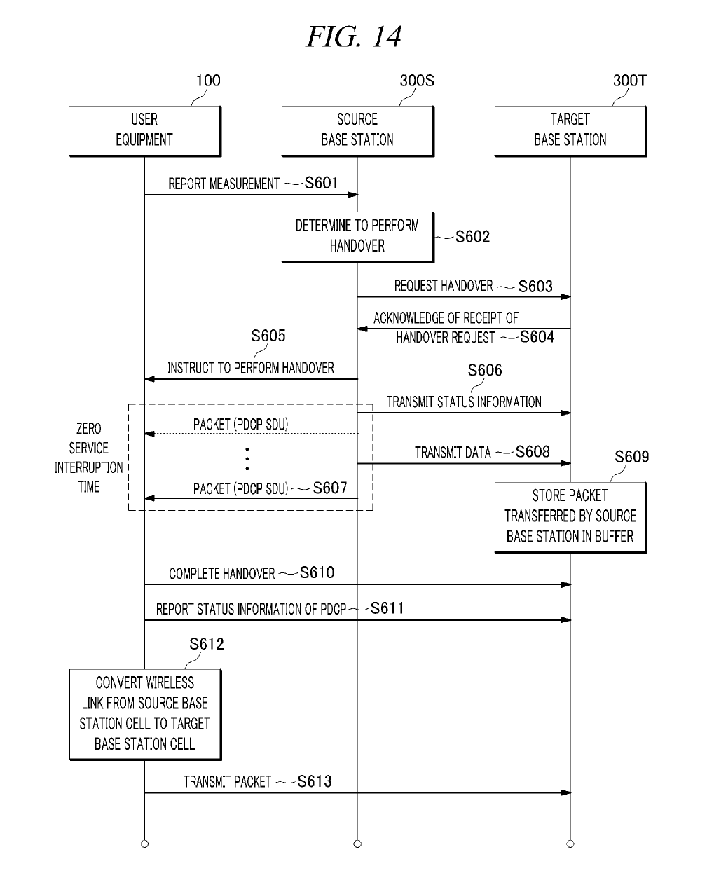

FIG. 14 illustrates a flow of a handover method without a service interruption in a wireless communication system to which still another exemplary embodiment of the present disclosure is applied.

If a signal quality of the source base station 300S is lower than a certain reference value or less, the UE 100 measures signal qualities of the source base station 300S and a neighbor base station 300 and reports the signal qualities to the source base station 300S (S601).

Then, the source base station 300S determines whether or not to perform a handover on the basis of the report (S602).

Then, the source base station 300S performs a handover to the target base station 300T and the UE 100 (S603, S604), and gives an instruction to the UE 100 to perform a handover to the target base station 300T (S605).

Further, the source base station 300S transfers information about a status of the UE 100 to the target base station 300T (S606).

Further, the source base station 300S may transfer data of a packet, which are stored to be transferred to the UE 100 but not transferred, to the target base station 300T (S608), and the target base station 300T stores packets transferred from the source base station 300S in a buffer (S609).

The above-described steps are the same as those of the conventional technology illustrated in FIG. 12. However, according to the conventional technology, the UE 100 cannot receive a packet transferred from the source base station 300S during a handover, whereas according to an exemplary embodiment of the present disclosure, while the above-described steps S606 to S608 are performed, the packets stored in the buffer of the source base station 300S can be continuously transferred to the UE 100 (S607). Therefore, as illustrated in FIG. 14, the UE 100 may not undergo a service interruption.

Then, the UE 100 reports that access to the target base station 300T is completed (S610).

Further, the UE 100 reports the numbers of the packets, which are appropriately received from the source base station 300S, to the target base station 300T (S611). Herein, in S607, the report may include the numbers of the appropriately received packets.

Then, the UE 100 changes the data plane setup from the communication with the source base station 300S to the communication with the target base station 300T (S612).

The target base station 300T transfers packets, which are stored in the buffer but not received by the UE 100, to the UE 100 (S613).

As described above, in order for the data plane to continuously receive a data packet from the source base station 300S while the control plane of the UE 100 performs a handover, the UE 100 needs to have two or more communication modules.

Therefore, the UE 100 in accordance with an exemplary embodiment of the present disclosure may have a dual-mode capability. By way of example, as shown in the above-described exemplary embodiment, the second communication module 150M of the UE 100 may transmit/receive a message for performing a control plane handover to/from the target base station 300T at the same time when the first communication module 140M may transmit/receive data plane data to/from the source base station 300S.

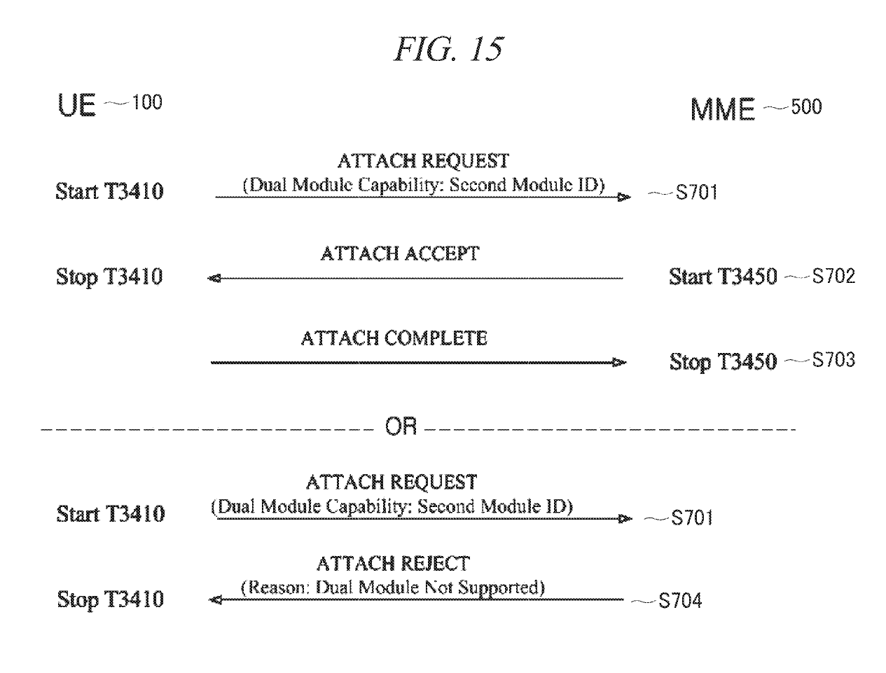

However, in order to use two or more communication modules at the same time, the UE 100 needs to inform the MME 500 that the UE 100 has a dual-mode capability. Details thereof will be described with reference to FIG. 15.

FIG. 15 illustrates a flow of a method for attaching a dual-mode capability of a wireless communication system to which still another exemplary embodiment of the present disclosure is applied.

FIG. 15 shows an example of negotiation with a dual-mode capability during an attachment process of the MME 500 with respect to a NAS layer.

Firstly, the UE 100 informs the MME 500 that the UE 100 is a device having a dual-mode capability and then requests attachment (S701). Herein, the UE 100 may inform the MME 500 of which communication module is bound to the UE 100. That is, the UE 100 informs the MME 500 of the current communication module as a primary communication module together with ID of a secondary communication module.

By way of example, when the current primary communication module of the UE 100 is the first communication module 140M, an attachment process is performed by the first communication module 140M and ID of the second communication module 150M is informed.

Meanwhile, the MME 500 allows (S703) or rejects (S704) the attachment. If the attachment is allowed, the UE 100 sends an attachment completion message to the MME 500 (S703).

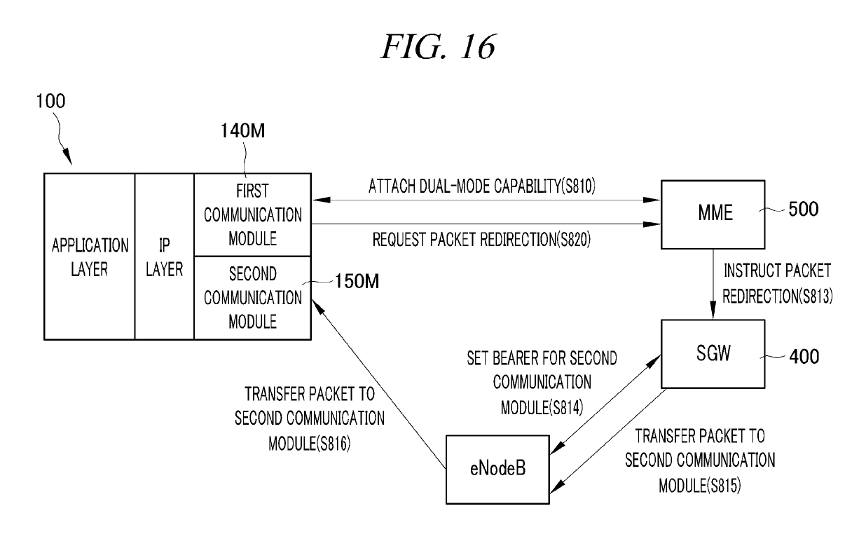

Hereinafter, a method of receiving a data packet by a secondary communication module (e.g.: the second communication module 150M) instead of the primary communication module (e.g.: the first communication module 140M) and a method of canceling a redirection of the data packet will be described with reference to FIG. 16 to FIG. 19. A handover to a homogenous small cell SC and a heterogeneous small cell (e.g.: WiFi network) will also be descried.

FIG. 16 illustrates a flow of a dual-mode communication method in a wireless communication system to which still another exemplary embodiment of the present disclosure is applied.

The primary communication module (e.g.: 140M) of the UE 100 attaches a dual-mode capability to the MME 500 as described with reference to FIG. 15 (S810).

Then, the primary communication module (e.g.: 140M) of the UE 100 requests a packet redirection from the MME 500 (S812). This can be used in the same situation as the above-described handover.

Then, the MME 500 gives an instruction to the SGW 400 to perform a packet redirection (S813).

The SGW 400 sets the base station 300 and a bearer for the secondary communication module (e.g.: 150M) (S814).

The SGW 400 transfers a packet, which will be transferred to the secondary communication module (e.g.: 150M) of the UE 100, to the base station 300 communicating with the secondary communication module (e.g.: 150M) (S815).

The base station 300 transfers the packet to the secondary communication module (e.g.: 150M) of the UE 100 (S816).

In other words, as described above, the UE 100 negotiates with the NAS positioned in the MME 500 about a dual-mode capability and attaches the dual-mode capability (S810). After the attachment, the communication of the first communication module 140M and the second communication module 150M is bound.

In this circumstance, if it is necessary to receive a packet by the second communication module 150M as shown in the above-described handover example, a packet redirection is requested (S812).

The MME 500 is an entity in charge of control such as mobility management, and, thus, in order to redirect a packet, the MME 500 gives an instruction to the SGW 400 to perform a packet redirection (S813).

The SGW 400 sets the base station 300 and a bearer in order to transfer a packet to the second communication module 150M (S814). Herein, the base station 300 with a set bearer may be different from the base station 300 connected to and communicating with the first communication module 140M.

The set bearer may transfer the packet being transferred to the first communication module 140M to the second communication module 150M (S815).

The base station 300 may transfer the received packet to the second communication module 150M through a wireless interface (S816).

The UE 100 is configured to have the same IP layer. Thus, even if a packet is transferred to different communication modules from a lower layer of the wireless communication module, an IP packet is configured with the same packet. Therefore, the UE 100 can receive and process a redirected packet while performing a communication operation.

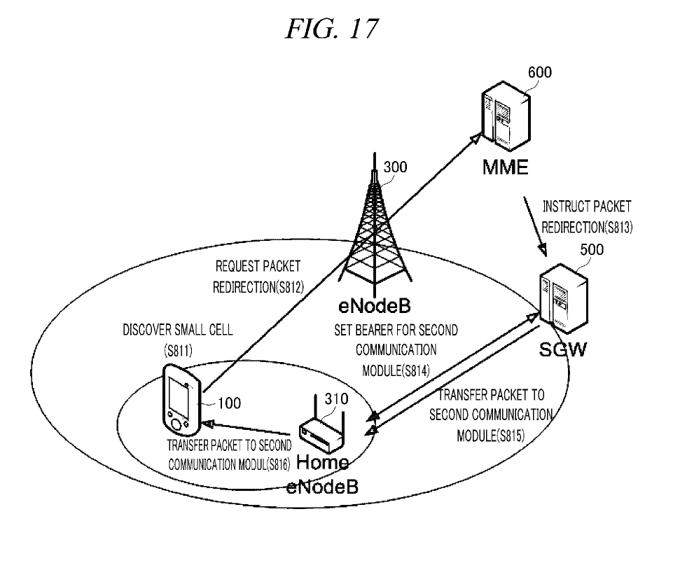

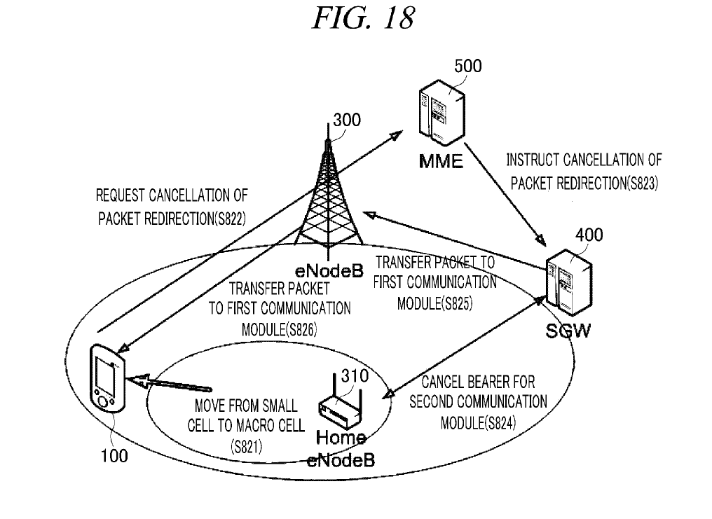

FIG. 17 illustrates a flow of an example of starting a dual-mode communication in the wireless communication system to which still another exemplary embodiment of the present disclosure is applied. FIG. 17 illustrates an example where a handover to a small cell SC is performed.

Firstly, the small-sized base station 310 available to the UE 100 is searched (S811).

The primary communication module (e.g.: 140M) of the UE 100 requests a packet redirection from the MME 500 (S812).

The MME 500 gives an instruction to the SGW 400 to perform a packet redirection (S813).

The SGW 400 sets the small-sized base station 310 and a bearer (S814).

The SGW 400 transfers a packet, which will be transferred to the secondary communication module (e.g.: 150M) of the UE 100, to the small-sized base station 310 (S815).

The small-sized base station 310 transfers the packet to the secondary communication module (e.g.: 150M) of the UE 100 (S816).

In other words, FIG. 17 illustrates an example of a communication method using two communication modules when the UE 100 is moved to a small cell (SC) network according to the present disclosure.

A small cell SC is discovered (S811). Herein, the discovered small cell SC may be a homogenous femtocell or a heterogeneous WLAN network.

A request for packet redirection is made (S812). The request for packet redirection is received by the base station 300 and transferred to the MME 500. The request for packet redirection may be included in a handover signaling exchange.

The MME 500 gives an instruction to the SGW 400 to transfer a packet, which will be transferred to the UE 100, to the newly discovered small cell SC (S813).

The SGW 400 sets a bearer to which the packet is transferred together with the discovered small cell SC (S814).

The set bearer transfers the packet to the newly discovered small cell SC (S815).

The packet received by the small cell SC is transferred to the second communication module 150M of the UE 100 (S816).

FIG. 18 illustrates a flow of an example of terminating a dual-mode communication in the wireless communication system to which still another exemplary embodiment of the present disclosure is applied.

The UE 100 tries to move from the small cell base station 310 to the macro cell base station 300 (S821).

The primary communication module (e.g.: 140M) of the UE 100 requests cancellation of packet redirection from the MME 500 (S822).

The MME 500 gives an instruction to the SGW 400 to cancel the packet redirection (S823).

The SGW 400 releases the bearer connected to the secondary communication module (e.g.: 150M) of the UE 100 through the small-sized base station 310 (S824).

The SGW 400 transfers a packet, which will be transferred to the primary communication module (e.g.: 140M) of the UE 100, to the macro base station 300 (S825).

The macro base station 300 transfers the packet to the primary communication module (e.g.: 140M) of the UE 100 (S826).

In other words, FIG. 18 illustrates an example of a communication method using two communication modules when the UE 100 is moved from the small cell (SC) network to the macro base station 300 according to the present disclosure.

Deviation from the small cell (SC) network is found (S821).

A request for canceling a packet transfer is made (S822). Herein, the request for canceling may be included as a part of a handover.

The MME 500 gives an instruction to the SGW 400 to cancel a packet transfer (S823).

The SGW 400 releases a bearer set for transferring a packet to the small cell SC (S824), and transfers the packet to the base station 300 (S825). In S825, the previously established bearer can be used as it is. Thus, S825 and S824 can be performed at the same time.

The packet received by the base station 300 is transferred to the first communication module 140M of the UE 100 (S826).

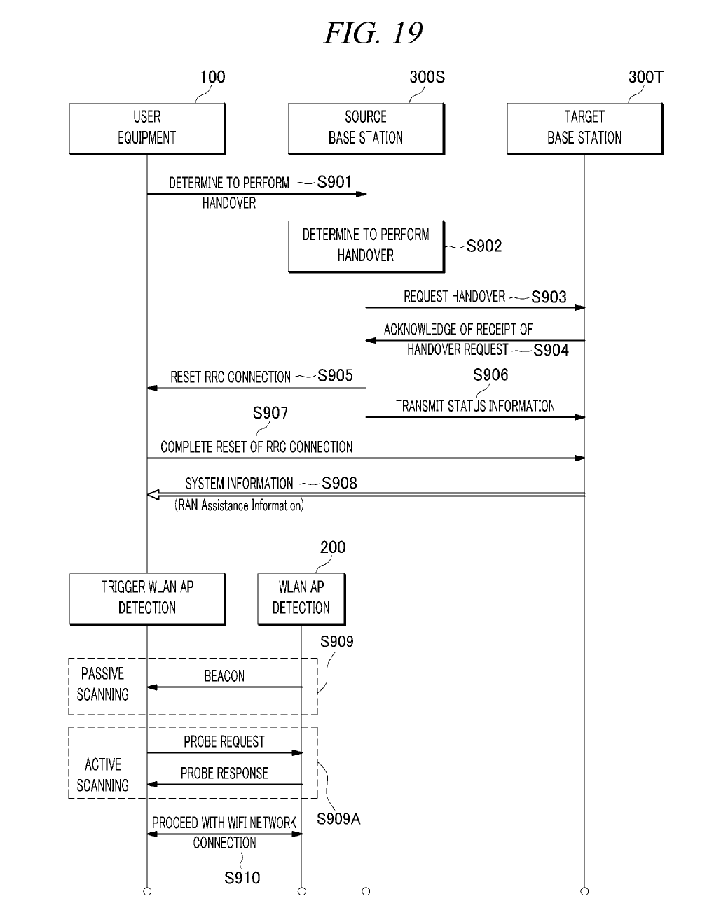

FIG. 19 illustrates a flow of an example of detecting a handover and a WLAN (WiFi) as a heterogeneous small cell in the wireless communication system to which still another exemplary embodiment of the present disclosure is applied.

If a signal quality of the source base station 300S is lower than a certain reference value or less, the UE 100 measures signal qualities of the source base station 300S and the neighbor base station 300 and reports the signal qualities (S901).

Then, the source base station 300S determines whether or not to perform a handover on the basis of the report (S902). Then, the source base station 300S performs a handover to the target base station 300T and the UE 100 (S903, S904), and gives an instruction to the UE 100 to perform a handover to the target base station 300T (RRC Connection Reconfiguration) (S905).

The source base station 300S transfers a status transfer message about a status of the UE 100 to the target base station 300T (S906).

After a new connection to the target base station 300T is set (RRC Connection Configuration Complete), information about a heterogeneous small cell SC to be detected is received (S907).

A passive scanning or an active scanning is performed on the basis of the received information about the heterogeneous small cell SC to detect the heterogeneous small cell SC and set a connection (S908).

The above descriptions can be summarized as follows.

One of the purposes of the exemplary embodiments of the present disclosure is to enable the UE 100 on the move to perform a handover while minimizing a service interruption.

Therefore, in the wireless communication method according to an exemplary embodiment of the present disclosure, the UE 100 includes the two communication modules 140M and 150M, and when a handover is performed to one (e.g.: 140M) of the two communication modules, the other communication module (e.g.: 150M) receives data. After the handover is performed, data may be received by the two (140M and 150M) or one (e.g.: 140M) communication module.

The two communication modules 140M and 150M of the UE 100 according to an exemplary embodiment of the present disclosure may respectively communicate with the source base station 300S and the target base station 300T using the antennas 140A and 150A spaced apart therefrom. Herein, the first communication module 140M performs a handover with the target base station 300T and the second communication module 150M performs data communication with the source base station 300S in order to avoid a service interruption.

A UE to which an exemplary embodiment of the present disclosure is applied may include a first communication module operating as a primary communication module and a second communication module operating as a secondary communication module. Therefore, while the first communication module performs communication for control, the second communication module may perform communication for data. Otherwise, while the first communication module performs a handover from a source base station to a target base station, the second communication module may receive a data packet from the source base station instead of the first communication module.

Alternatively, if the first communication module makes a request for packet redirection and cancels the packet redirection and the first communication module makes a request for packet redirection, the second communication module may receive a data packet instead of the first communication module makes.

Otherwise, the UE to which an exemplary embodiment of the present disclosure is applied may include a first antenna used for communication of the first communication module with the source base station and the target base station, and a second antenna used for communication of the second communication module with the source base station. Herein, the first antenna and the second antenna may be provided to be separate from each other. Alternatively, the first antenna and the second antenna may be provided outside the UE.

The first communication module and the second communication module included in the UE to which an exemplary embodiment of the present disclosure is applied may use different frequency bands.

Further, the UE to which an exemplary embodiment of the present disclosure is applied may attach the primary communication module and the secondary communication module through NAS communication with a core network.

The first communication module included in the UE to which an exemplary embodiment of the present disclosure is applied may request a packet redirection to the second communication module from the core network, and the core network may set a bearer and a base station to transfer a packet to the second communication module in response to the request.

A wireless communication system that provides a wireless communication service to the UE to which an exemplary embodiment of the present disclosure is applied may include a radio access network including a macro base station or a small cell base station, and a core network including a mobile management entity and a core network gateway. Herein, at the mobile management entity, the mobile device is attached as including the primary communication module and the secondary communication module. Further, when the primary communication module in the UE performs a handover from the source base station to the target base station, the secondary communication module may receive a data packet from the source base station instead of the primary communication module.

Furthermore, if the UE requests a packet redirection, the mobile management entity may give an instruction to the core network gateway to perform the packet redirection. The core network gateway may set a bearer and a base station to transfer the packet to the secondary communication module of the UE in response to the request for packet redirection and transfer the packet to the set base station.

Otherwise, if the UE requests cancellation of packet redirection, the mobile management entity may give an instruction to the core network gateway to cancel the packet redirection. The core network gateway releases the bearer and the base station to transfer the packet to the secondary communication module of the UE in response to the request for cancellation of packet redirection and transfer the packet to a base station communicating with the primary communication module of the UE.

A method for providing the wireless communication service to the UE including the primary communication module and the secondary communication module using the wireless communication system to which an exemplary embodiment of the present disclosure is applied may include: requesting, by the UE, a packet redirection from the mobile management entity; instructing, by the mobile management entity, the core network gateway of the wireless network system to perform a packet redirection; setting a bearer and a base station to transfer a packet to the secondary communication module in response to the request for packet redirection and transferring the packet to the set base station by the core network gateway; and receiving the packet by the secondary communication module of the UE.

Otherwise, the method for providing the wireless communication service to the UE including the primary communication module and the secondary communication module using the wireless communication system to which an exemplary embodiment of the present disclosure is applied may further include: attaching the UE as including the primary communication module and the secondary communication module at the mobile management entity.

The method for providing the wireless communication service to the UE including the primary communication module and the secondary communication module using the wireless communication system to which an exemplary embodiment of the present disclosure is applied may further include: requesting, by the UE, cancellation of packet redirection from the mobile management entity; instructing, by the mobile management entity, the core network gateway of the wireless communication system to perform a packet redirection; releasing the bearer and the base station to transfer the packet to the secondary communication module of the UE in response to the request for cancellation of packet redirection and transferring the packet to a base station communicating with the primary communication module of the UE by the core network gateway; and receiving the packet by the primary communication module of the UE.

Alternatively, the method may further include: performing a handover from a source base station to a target base station by the primary communication module of the UE; and receiving a data packet from the source base station by the secondary communication module of the UE at the same time as the handover.

Meanwhile, the performing a handover by the primary communication module of the UE may include requesting a packet redirection from the mobile management entity.

A handover method of the UE in the wireless communication system to which an exemplary embodiment of the present disclosure is applied may include: performing a handover from a source base station to a target base station by the primary communication module of the UE; and receiving a data packet from the source base station by the secondary communication module of the UE at the same time as the handover.

Otherwise, the performing a handover by the primary communication module of the UE may include requesting a packet redirection from the mobile management entity.

The exemplary embodiments can be embodied in a storage medium including instruction codes executable by a computer or processor such as a program module executed by the computer or processor. A data structure in accordance with the exemplary embodiments can be stored in the storage medium executable by the computer or processor. A computer-readable medium can be any usable medium which can be accessed by the computer and includes all volatile/non-volatile and removable/non-removable media. Further, the computer-readable medium may include all computer storage and communication media. The computer storage medium includes all volatile/non-volatile and removable/non-removable media embodied by a certain method or technology for storing information such as a computer-readable instruction code, a data structure, a program module or other data. The communication medium typically includes the computer-readable instruction code, the data structure, the program module, or other data of a modulated data signal such as a carrier wave, or other transmission mechanism, and includes information transmission mediums.

The method and system of the present disclosure has been explained in relation to a specific embodiment, but its components or a part or all of its operations can be embodied by using a computer system having general-purpose hardware architecture.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A method for searching a wireless LAN by a mobile device, comprising:
receiving, by the mobile device, a setting parameter required to start searching for a wireless LAN access point from a base station;
determining, by the mobile device, whether or not to start searching for the wireless LAN access point on the basis of the setting parameter; and
starting, by the mobile device, searching for the wireless LAN access point if a condition for starting a search is satisfied.

2. The method for searching a wireless LAN of claim 1,
wherein the setting parameter required to start searching includes one or more of an installation density of wireless LANs, a wireless LAN coverage, and a reference value for scanning mobility.

3. The method for searching a wireless LAN of claim 2,
wherein the reference value for scanning mobility is a reference value used to start searching for the wireless LAN access point, and the reference value is selected using movement speed statistics of a user.

4. The method for searching a wireless LAN of claim 1,
wherein the determining whether or not to start searching for the wireless LAN access point comprises:
delaying the search for the wireless LAN access point if a movement speed of the mobile device is higher than the reference value for scanning mobility; and
starting the search for the wireless LAN access point at the time when the movement speed of the mobile device becomes lower than the reference value for scanning mobility.

5. The method for searching a wireless LAN of claim 4,
wherein the determining whether or not to start searching for the wireless LAN access point further comprises:
activating a trigger timer when the mobile device starts a movement,
wherein the trigger timer is activated when the mobile device starts a movement, and when the activation of the trigger timer is expired, the mobile device compares the movement speed of the mobile device with the reference value for scanning mobility.

6. The method for searching a wireless LAN of claim 4,
wherein the determining whether or not to start searching for the wireless LAN access point further comprises:
transmitting, by the base station, information about a trigger timer that activates a search start time of the mobile device to the mobile device.

7. The method for searching a wireless LAN of claim 4,
wherein the delaying the search for the wireless LAN access point if a movement speed of the mobile device is higher than the reference value for scanning mobility further comprises:
measuring the movement speed,
wherein a method of measuring the movement speed includes any one of a method using a Doppler shift, a method of counting the number of handovers, a method using a strength of a received signal, or a method using a GPS.

8. The method for searching a wireless LAN of claim 4,
wherein the determining whether or not to start searching for the wireless LAN access point further comprises:
activating a trigger timer when the mobile device starts a movement,
wherein the trigger timer is not activated at the time when a user starts a movement while getting on a vehicle provided with a wireless LAN access point according to options set by the user.

9. A mobile device comprising:
a memory in which a program for performing a wireless LAN search is stored;
one or more communication interface modules; and
a processor which executes the program stored in the memory,
wherein when the program is executed, the processor receives a setting parameter required to start searching for a wireless LAN access point through a virtualization layer and sets an operation parameter according to the received setting parameter.

10. The mobile device of claim 9, further comprising:
a LTE protocol layer and a WiFi protocol layer,
wherein the processor requests mobility information required to start searching for a wireless LAN access point from the LTE protocol layer through the virtualization layer, transfers mobility information depending on whether or not an event occurs to the virtualization layer through the LTE protocol layer, and
if the mobility information satisfies a condition for starting a wireless LAN search, the processor instructs the WiFi protocol layer to perform the search for the wireless LAN through the virtualization layer, and
if the wireless LAN search is successfully performed, the processor requests cancellation of a transfer of mobility information from the LTE protocol layer through the virtualization layer.

11. The mobile device of claim 9,
wherein the processor controls an operation of a trigger timer in the virtualization layer, and activates the trigger timer when the mobile device starts a movement.

12. The mobile device of claim 11,
wherein the trigger timer is activated when the mobile device starts the movement, and when the activation of the trigger timer is expired, the processor compares a movement speed of the mobile device with a reference value for scanning mobility.

13. The mobile device of claim 11,
wherein the trigger timer is not activated at the time when a user starts a movement while getting on a vehicle provided with a wireless LAN access point according to options set by the user.

14. The mobile device of claim 9,
wherein if the parameter is a value for scanning mobility, the processor delays the search for the wireless LAN access point if a current movement speed of the mobile device is higher than the reference value for scanning mobility, and starts the search for the wireless LAN access point at the time when the movement speed of the mobile device becomes lower than the reference value for scanning mobility.
